(19) United States
(12) Patent Application Publication
(10) Pub. No.: US 2010/0045893 A1
(43) Pub. Date: Feb. 25, 2010

(54) LED DISPLAY DEVICE

(76) Inventor: Jung Hwa CHIANG, Chung-Ho City (TW)

Correspondence Address: Guice Patents PLLC, 12647 Galveston Court #302, Manassas, VA, 20112, US

(21) Appl. No.: 12/208,292

(22) Filed: Sep. 10, 2008

(30) Foreign Application Priority Data
Aug. 21, 2008 (TW) 097214992

(51) Int. Cl. G02F 1/1335

(52) U.S. Cl. 349/61

(57) ABSTRACT

The present invention relates to a LED display device, comprises: a first modulating module capable of outputting a first modulation controlling signal; plural LEDs, wherein one end of the plural LEDs is coupled with a display information; at least one first driving unit; and a first scanning module for outputting a first scanning signal to the first driving unit to drive the first driving unit, so the plural LEDs are in turn conducted so as to achieve an energy saving function.

### BACKGROUND OF THE INVENTION

1. Field of the Invention

The present invention relates to a display device, more particularly to a LED display device in which means of pulse width modulation and rapid scan are adopted so as to in turn conduct plural LEDs therefore an energy saving function is achieved.

2. Description of Related Art

A conventional liquid crystal display device, especially the liquid crystal display device used in a notebook computer, is provided with a cold cathode fluorescent lamp (CCFL) serving as its backlight source, but a CCFL consumes more power so the standby time of the notebook computer is reduced and the exceeding power consumed is not environmental friendly.

LEDs are adopted by some skilled people in the art and are served as a backlight source for a liquid crystal display device, but only a means of pulse width modulation is adopted for controlling the conduction of the LEDs so that the current and the brightness of the LEDs are raised; therefore the adopted LEDs can be served to replace a CCFL, but continuing lighting up the LEDs not only consumes power but also generate thermal energy.

### SUMMARY OF THE INVENTION

One object of the present invention is to provide a LED display device in which means of pulse width modulation and rapid scan are adopted so as to in turn conduct plural LEDs therefore an energy saving function is achieved.

Another object of the present invention is to provide a LED display device in which a means of pulse width modulation is adopted for lowering work duties of modulation signals and for raising driving currents of the modulation signals, so less quantity of LEDs is needed and the whole brightness of the adopted LEDs is raised.

One another object of the present invention is to provide a LED display device that is capable of modulating one single LED so as to save energy.

For achieving the objects mentioned above, a LED display device is provided by the present invention, comprises: a first modulating module capable of outputting a first modulation controlling signal; plural LEDs, wherein one end of the plural LEDs is coupled with a display information; at least one first driving unit, which is a three-terminal unit, wherein a first terminal of the first driving unit is coupled with the other end of at least one of the plural LEDs, a second terminal thereof is coupled with the first modulation controlling signal; and a first scanning module coupled with a third terminal of the first driving unit for outputting a first scanning signal to the first driving unit to drive the first driving unit, so the plural LEDs are in turn conducted so as to achieve an energy saving function.

### BRIEF DESCRIPTION OF THE DRAWINGS

FIG. 1 is a block diagram of one preferred embodiment of the LED display device provided by the present invention;

FIG. 2 is a schematic view illustrating the first modulating module outputting signals;

FIG. 3 is a schematic view of a circuit of one preferred embodiment of the LED display device provided by the present invention;

FIG. 4 is a schematic view of a first scanning signal of one preferred embodiment of the present invention;

FIG. 5 is a block diagram of another preferred embodiment of the LED display device provided by the present invention.

### DETAILED DESCRIPTION OF THE PREFERRED EMBODIMENT

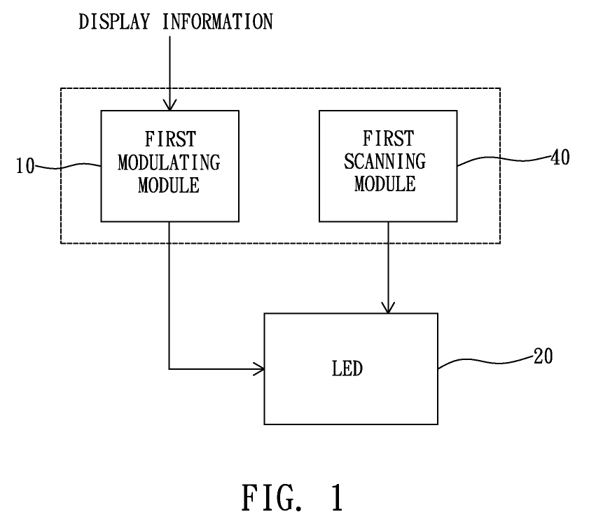

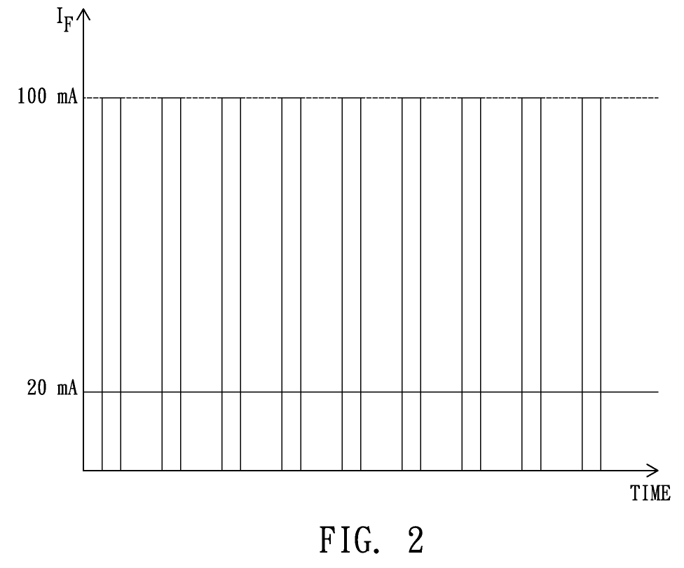

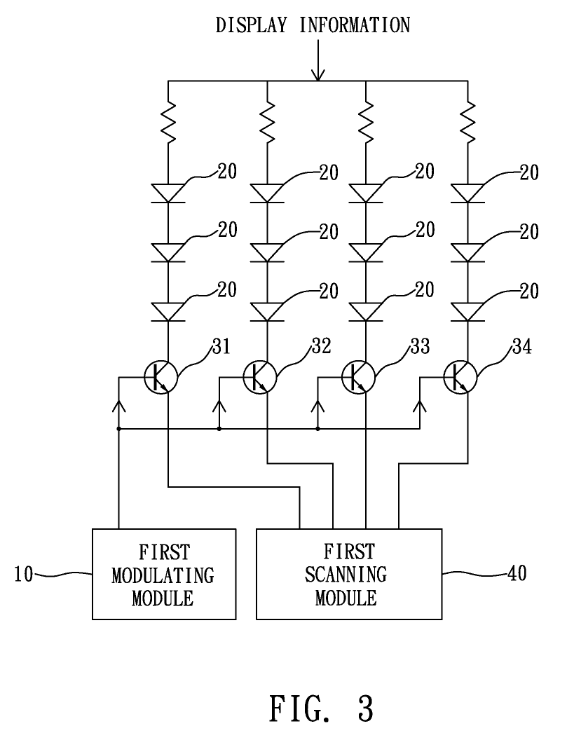

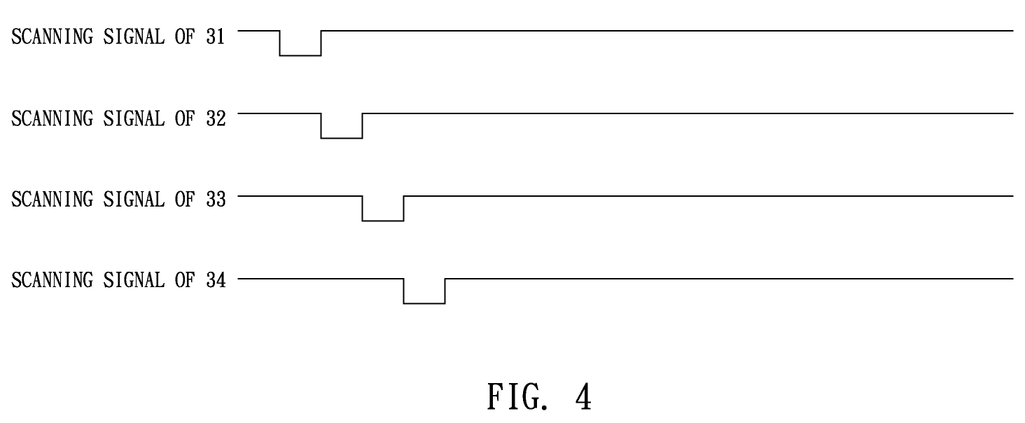

Referring to FIG. 1 to FIG. 4, in which FIG. 1 is a block diagram of one preferred embodiment of the LED display device provided by the present invention; FIG. 2 is a schematic view illustrating the first modulating module outputting signals; FIG. 3 is a schematic view of a circuit of one preferred embodiment of the LED display device provided by the present invention; FIG. 4 is a schematic view of a first scanning signal of one preferred embodiment of the present invention.

As shown in figures, the LED display device provided by the present invention and capable of being served as a backlight source of a notebook computer or a liquid display device, comprises: a first modulating module 10; plural LEDs 20; at least one first driving unit 31˜34; and a first scanning module 40.

The first modulating module 10 is capable of outputting a first modulation controlling signal, wherein the output signal can be modulated to a pulse width modulated signal as shown in FIG. 2 by the first modulating module 10 via a means of pulse width modulation, so work duties of the plural LEDs 20 are controlled, and objects of raising the current and the brightness are achieved; a work duty of a driving signal of a conventional LED is about 50% and the driving current is about 20 mA; the first modulating module 10 can be served to modulate the work duty of the first modulation controlling signal to, e.g. but not limited to, 1/10, so the driving current can reach about several-hundred mA and the brightness of the LEDs 20 is therefore increased.

The plural LEDs 20 is, but not limited to, a high-brightness LED whose color can be monochromatic or polychromatic, and can be served as a light source of a backlight, and one end of the plural LEDs 20 is coupled in series and/or in parallel with a display information, for example as shown in FIG. 3 that the connection between the LEDs 20 and the display information is firstly in series then in parallel; wherein one end of at least one LED of the plural LEDs 20 is coupled with an output end of the modulating module 10; in this embodiment, three of the LEDs 20 are firstly connected in series then are connected in parallel with the other LEDs 20. One end of the plural LEDs 20 is coupled with the display information, and the display information can be output by a micro controller (not shown), and generally are 0/1 signals.

The at least one first driving unit 31˜34 is a three-terminal unit, a first terminal of the first driving unit is coupled with the other end of at least one of the plural LEDs 20, a second terminal thereof is coupled with the first modulation controlling signal outputted by the first modulating module 10, a third terminal thereof is coupled with the scanning module 40, the quantity of the first driving units 34 is corresponding to the quantity of the LEDs 20 connected in parallel, in this embodiment four driving units 31˜34 are adopted for illustration. Each of the first driving units 31˜34 is, e.g. but not limited to, a NPN or a PNP transistor, in this embodiment a NPN transistor is adopted for illustration, and a first terminal thereof is, but not limited to, a collector, a second terminal thereof is, but not limited to, a base, and a third terminal thereof is, but not limited to, an emitter.

One end of the first scanning module 40 is coupled with a third terminal of the first driving unit 31˜34 for outputting a first scanning signal to the first driving unit 31˜34 to drive the first driving unit 31˜34, the plural LEDs 20 are arranged to 4 rows connected in parallel so each of the four rows is in turn conducted so a function of energy saving is achieved.

As shown FIG. 4, one feature of the present invention is that the first scanning signal outputted by the first scanning module 40 is outputted to the first driving unit 31˜34, and the first driving unit 31˜34 is in turn driven via a means of time division multiple (TDM); for example each of the driving units 31˜34 is conducted for ¼ of the time, wherein the frequency of the first scanning signal is, but not limited to, 30 Hz so a vision persistence effect is provided to a user and the user can not tell the LEDs 20 are lit up via a means of time division multiple, therefore the power consumed is reduced and thermal energy generated by the LEDs 20 is decreased.

The first modulating module 10 and the first scanning module 40 can be provided in an integrated circuit for lowering the production cost.

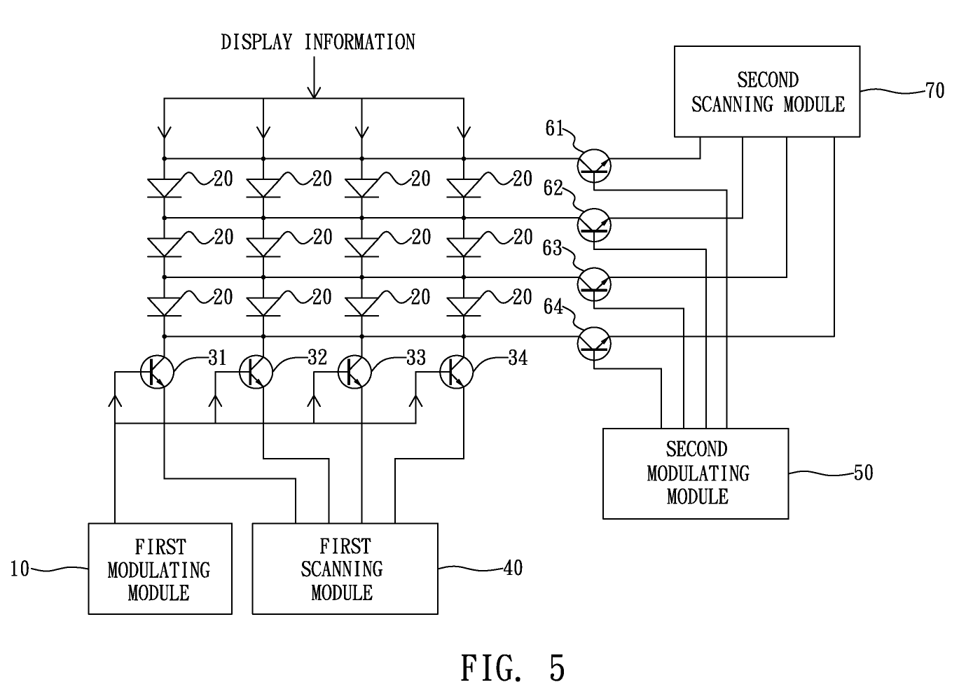

Referring to FIG. 5, which is a block diagram of another preferred embodiment of the LED display device provided by the present invention. As shown in figure, the LED display device provided by the present invention further comprises: a second modulating module 50, at least one second driving unit 61˜64; and a second scanning module 70.

The second modulating module 50 is capable of outputting a second modulation controlling signal, wherein the outputted signal can be modulated to a pulse width modulated signal as shown in FIG. 2 by the second modulating module 50 via a means of pulse width modulation, so work duties of the plural LEDs 20 are controlled, and objects of raising the current and the brightness are achieved; wherein the work duties are, but not limited to, 1/10, the current can reach to about several-hundred mA, so the brightness of the LEDs 20 is therefore increased.

The at least one second driving unit 61˜64 is a three-terminal unit, a first terminal of the second driving unit is coupled with the other end of at least one of the plural LEDs 20, a second terminal thereof is coupled with the second modulation controlling signal outputted by the second modulating module 50, the quantity of the second driving unit is corresponding to the quantity of the LEDs 20 connected in parallel, in this embodiment, four second driving units 61˜64 are adopted for illustration. Each of the second driving units 61˜64 is, but not limited to, a NPN or a PNP transistor, in this embodiment a NPN transistor is adopted for illustration, and a first terminal thereof is, but not limited to, a collector, a second terminal thereof is, but not limited to, a base, and a third terminal thereof is, but not limited to, an emitter.

The second scanning module 70 is coupled with a third terminal of the second driving unit 61˜64 for outputting a second scanning signal to the second driving unit 61˜64 to respectively drive the second driving unit 61˜64, so every single one of the LEDs 20 provided is in turn conducted therefore an energy saving function is achieved; wherein the frequency of the second scanning signal is, but not limited to, 30 Hz so a vision persistence effect is provided to a user and the user can not tell the LEDs 20 are lit up via a means of time division multiple, therefore the power consumed is reduced and thermal energy generated by the LEDs 20 is decreased.

The second modulating module 50 and the second scanning module 70 can be provided in an integrated circuit for lowering the production cost.

The LED display device provided by the present invention utilizes means of the described pulse width modulation and rapid scan so that the plural LEDs are in turn conducted, therefore the energy saving function is achieved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A LED display device, served as a backlight source for a liquid crystal display device, comprises:
a first modulating module capable of outputting a first modulation controlling signal;
plural LEDs, wherein one end of the plural LEDs is coupled with a display information;
at least one first driving unit, which is a three-terminal unit, wherein a first terminal of the first driving unit is coupled with the other end of at least one of the plural LEDs, a second terminal thereof is coupled with the first modulation controlling signal;
a first scanning module coupled with a third terminal of the first driving unit for outputting a first scanning signal to the first driving unit to drive the first driving unit, so the plural LEDs are in turn conducted;
a second modulating module capable of outputting a second modulation controlling signal;
at least one second driving unit, which is also a three-terminal unit, wherein a first terminal of the second driving unit is coupled with the other end of at least one of the plural LEDs, a second terminal thereof is coupled with the second modulation controlling signal; and
a second scanning module coupled with a third terminal of the second driving unit for outputting a second scanning signal to the second driving unit to drive the second driving unit, so the plural LEDs are in turn conducted, therefore an energy saving function is provided.

2. The LED display device as claimed in claim 1, wherein the plural LEDs are connected in series and/or in parallel.

3. The LED display device as claimed in claim 2, wherein the plural LEDs are firstly connected in series then connected in parallel.

4. The LED display device as claimed in claim 1, wherein the first driving unit is a transistor and the second driving unit is a transistor.

5. The LED display device as claimed in claim 1, wherein the frequency of the first scanning signal and the frequency of the second scanning signal are at least 30 Hz.

6. The LED display device as claimed in claim 1, wherein the first modulating module and the first scanning module, the second modulating module and the second scanning module are respectively provided on an integrated circuit.

7. The LED display device as claimed in claim 1, wherein the first modulating module is a pulse width modulating module and the second modulating module is a pulse width modulating module, and work duties of the first modulating signal and the second modulating signal are 1/10, the current reaches several-hundred mA, for increasing the brightness of the LEDs.

8. The LED display device as claimed in claim 1, wherein every row arranged with the LEDs is in turn conducted by the first scanning module, every one of the LEDs is in turn conducted by the second module so as to save energy.
